(19) United States
(12) Patent Application Publication
(10) Pub. No.: US 2012/0224259 A1
(43) Pub. Date: Sep. 6, 2012

(54) PICTURE CHANGEABLE STREOSCOPIC POSTING APPARATUS

(76) Inventor: Hae-Yong CHOI, Seoul-city (KR)

(21) Appl. No.: 13/351,267

(22) Filed: Jan. 17, 2012

(30) Foreign Application Priority Data
Mar. 2, 2011 (KR) 10-2011-0018341
Mar. 23, 2011 (KR) 10-2011-0025691
Apr. 4, 2011 (KR) 10-2011-0030524

(51) Int. Cl. G02B 27/22

(52) U.S. Cl. 359/463

(57) ABSTRACT

A picture changeable stereoscopic posting apparatus, comprising: a front case and a main body case formed as a frame, respectively; a lenticular plate mounted on the front case; a picture fixing device for fixing a 3D picture provided on a rear surface of the lenticular plate; a 3D picture which is printed on a separate printing paper and includes a left eye picture and a right eye picture which are fine-divided into a plurality of pictures and are arranged vertically in sequence to be combined as single picture; and a resilient plate which is made of elastic material such as sponge or urethane sheet and is provided inside the main body case wherein the front case is opened from the main body case for the 3D picture 5 to be replaced frequently.

This application claims priority of Korean Patent Application No. 10-2011-0018341, 10-2011-0025691 and 10-2011-0030524 filed in the Korean Intellectual Property Office, which is hereby incorporated by reference in its entirety.

### BACKGROUND OF THE INVENTION

1. Field of the Invention

The present invention relates to a stereoscopic posting apparatus for a movie poster and a drama poster, etc., in which 3D images can be viewed without a 3D glass and 3D posters can be exchanged frequently and simply, and mass posting of the posters is possible.

2. Description of the Related Art

In general, a poster for advertising a movie has to be exchanged frequently since a content of movie is changed frequently. Further, the posters are disposed on many places and thus they have to be exchanged easily by some persons who do not have specific knowledge and further mass production and exchanging thereof have to be possible. Specially, 3D movie has to be posted through a 3D poster to advertize efficiently it; however, a 2D poster has been used for advertizing the 3D movie, instead of 3D poster.

Here, as a posting method for advertizing a 3D movie without using a 3D glass, a 3D card may be used; however, 3D images themselves have to be printed on a rear surface of a lenticular plate to use the 3D card. Further, in the 3D card posting manner, a lens pitch distance of the lenticular plate has to correspond to a distance between left image and right image of 3D image and the 3D image has to be adhered to a rear surface of the lenticular plate without distance and thus the left and right image of the 3D image have to be printed on a rear surface of the lenticular plate.

Here, referring an image printing method or combining method to a lenticular plate itself, there arises a problem in that the lenticular plate is to be disposable and thus it cannot be reused, Further, a cost of the lenticular plate is high. Accordingly, it cannot be used for a movie poster where a picture thereof is large and a large amount has to be displayed and further it has to be exchanged frequently whenever the contents of the movie is changed on a many places.

Further, in U.S. Pat. No. 7,210,257, it has been disclosed that a picture is adhered to a lenticular plate using a vacuum pump wherein it is only a kind of a device showing two pictures in a state of the lenticular plate being moved and thus it is not a sowing device for a 3D movie. Furthermore, the device as described in the forgoing is complicated configuration and picture exchanging process is not simple and thus it cannot be applicable to a movie poster where a picture has to be exchanged frequently.

In U.S. Pat. No. 7,312,923, two pictures are viewed in parallel through a lens sheet over a bearing configuration while they are moved leftward and rightward; however, it cannot be applicable to 3D image and further cannot be used as a 3D movie poster where a picture can be exchanged easily and simply and a large amount of posters has to be exchanged.

In US Patent Publication No. 2010/018621, a lens sheet is moved leftward and rightward through a motor or a actuate elastic element to show two pictures; however, it cannot be applicable to a 3D image and cannot be used as a 3D poster where poster where a picture can be exchanged easily and simply and a large amount of posters has to be exchanged.

According to the configurations of a prior art as described in the forgoing, pictures are moved to show two pictures on a poster or pictures are fixed through complicated structure and thus they cannot be applicable to 3D image or used as a posting device of 3D image.

### SUMMARY OF THE INVENTION

An aspect of the present invention is directed to a picture changeable stereoscopic posing apparatus in which only the picture is replaced without changing a lenticular plate and thereby mass-replacing 3D posters.

Another aspect of the present invention is directed to a picture changeable stereoscopic posing apparatus in which lens pitch of the lenticular plate corresponds to an interval of the 3D picture and thus anyone can replace the 3D picture and display simply 3D images.

Yet another aspect of the present invention is directed to a picture changeable stereoscopic posing apparatus in which 3D picture can be mass-produced.

Still yet another aspect of the present invention is directed to a picture changeable stereoscopic posing apparatus through which 3D mobile image can be viewed, together with the printed 3D image.

In a preferred embodiment of the present invention, a picture changeable stereoscopic posing apparatus includes: a main body case and a front case wherein the front case can be separated from the main body case; a lenticular plate installed fixedly to a inner-front surface of the front case; a picture fixing device for fixing or separating a 3D picture, provided on the front case or the lenticular plate, or a rear surface of the main body case; a resilient plate made of elastic material such as sponge or urethane, which is provided on the main body case; and a 3D picture which is printed on a separate printing paper and includes left-right eye pictures, which are fine-divided vertically and arranged in sequence wherein the 3D picture is mounted to the fixing device on a rear surface of the lenticular plate of the front case to be separate frequently.

A fixing groove is formed on a location corresponding automatically to a location where the fixing device is placed wherein a lens interval of the lenticular plate and a picture interval are viewed as 3D image.

The 3D picture as a poster is provided such that the 3D picture can be mass-produced by mass-printing it on a general printing paper such as independent separate paper or film sheet using a general printing method.

Further, monitor windows are provided on a part of the lenticular plate and a part of the 3D picture so that 3D poster and 3D mobile image can be viewed, using eye-glassless 3D monitor.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a perspective view illustrating an image changeable stereoscopic posting apparatus according to the present invention;

FIG. 2 is a sectional view illustrating an image changeable stereoscopic posting apparatus according to the present invention;

FIG. 3 is a view illustrating some elements of an image changeable stereoscopic posting apparatus according to the present invention;

FIG. 4 is a perspective view illustrating a lens interval of a lenticular plate and 3D image interval of an image changeable stereoscopic posting apparatus according to the present invention;

FIG. 5 is a perspective view illustrating a fixing frame of a lenticular plate and a fixing frame of a 3D image of an image changeable stereoscopic posting apparatus according to the present invention;

FIG. 6 is a perspective view illustrating a fixing pin of a lenticular plate and a fixing groove of a 3D image of an image changeable stereoscopic posting apparatus according to the present invention;

FIG. 7 is a perspective view illustrating an assembled configuration of the fixing pin and the fixing frame of an image changeable stereoscopic posting apparatus according to the present invention;

FIG. 8 is a perspective view illustrating an assembled lighting plate of an image changeable stereoscopic posting apparatus according to the present invention;

FIG. 9 is a perspective view illustrating a curved lenticular plate of an image changeable stereoscopic posting apparatus according to the present invention;

FIG. 10 is a perspective view illustrating the lighting plate assembled to the curved lenticular plate of an image changeable stereoscopic posting apparatus according to the present invention;

FIG. 11 is a perspective view illustrating a 3D image monitor assembled into the lenticular plate of an image changeable stereoscopic posting apparatus according to the present invention;

FIG. 12 is a perspective view illustrating constitutional elements of FIG. 11;

FIG. 13 is a perspective view illustrating an image changeable stereoscopic posting apparatus according to the present invention provided with a water-proof ring;

FIG. 14 is a view illustrating a car provided with an image changeable stereoscopic posting apparatus according to the present invention;

FIG. 15 a view illustrating a bus provided with an image changeable stereoscopic posting apparatus according to the present invention; and

FIG. 16 a view illustrating an image changeable stereoscopic posting apparatus according to the present invention, configured as a circular shape.

### DETAILED DESCRIPTION OF EXEMPLARY EMBODIMENTS

Exemplary embodiments of the present invention will be described below in detail with reference to the accompanying drawings. Wherever possible, the same reference numerals will be used to refer to the same elements throughout the specification, and a duplicated description thereof will be omitted.

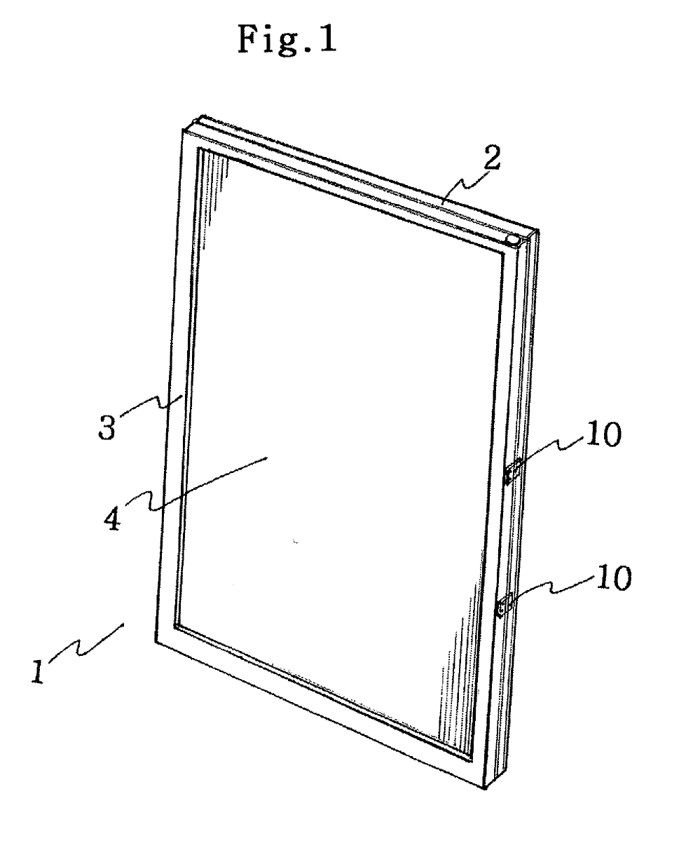

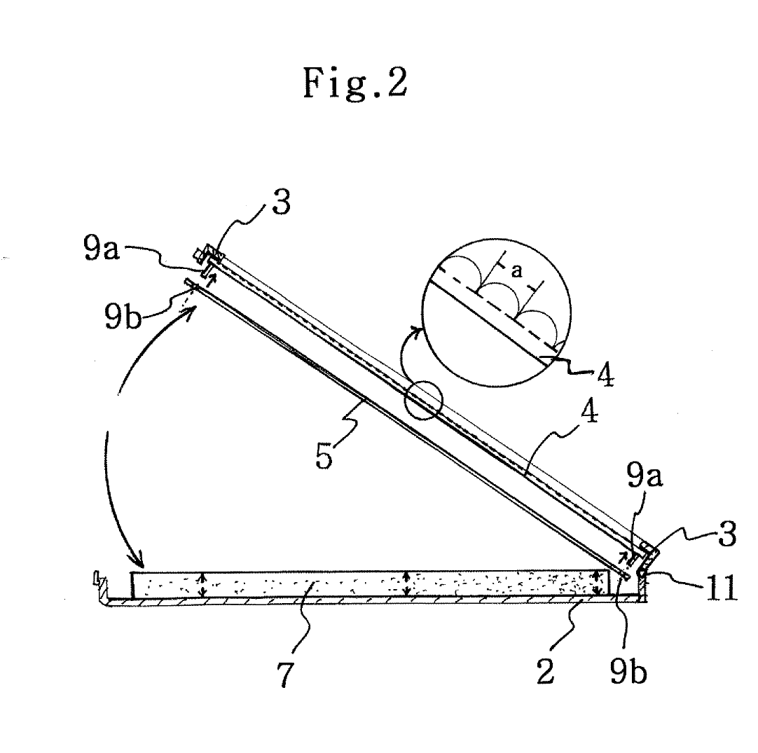

As shown in FIGS. 1-2, 5-6, 8-9, and 10-12, a lenticular plate 4 may be provided on a front case 3, which is made of frame metal material such as aluminum or plastic material, and further a fixing pin 9a or a fixing plate 9c may be provided on a rear surface of the front case 3 or the lenticular plate 4, or an inner side of a main body case 2, for mounting a 3D picture.

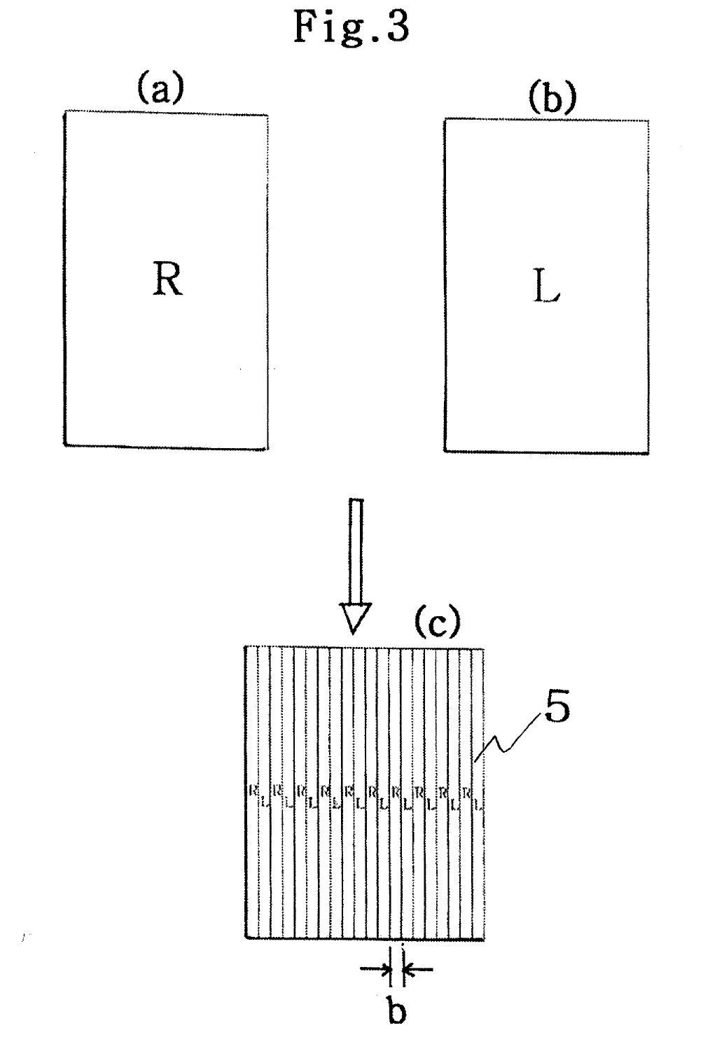

Here, the 3D picture 5 is configured in such a manner that, as shown in FIG. 3, a left-eye picture R and a right-eye picture L are arranged up-downwardly in sequence on a separate paper or a film which can be mass-manufactured by a printing process, separating from each other at a picture space b corresponding to a lens interval of the lenticular plate 4 and then printed by a general printing method to complete the 3D picture 5.

In more detailed description of the 3D picture 5, as shown in FIG. 3(a), a left-eye picture (R) to be viewed on a left eye of a viewer and a right-eye picture (L) to be viewed on a right eye of the viewer, as shown in FIG. 3(b), are arranged up-downwardly at a fine interval wherein the left-eye picture (R) and the left-eye picture (L) are arranged and edited in sequence.

The edited picture manuscript can be mass-produced on a low cost since it can be printed on a separate printing paper such as a general printing, in addition to be printed on the lenticular plate 4.

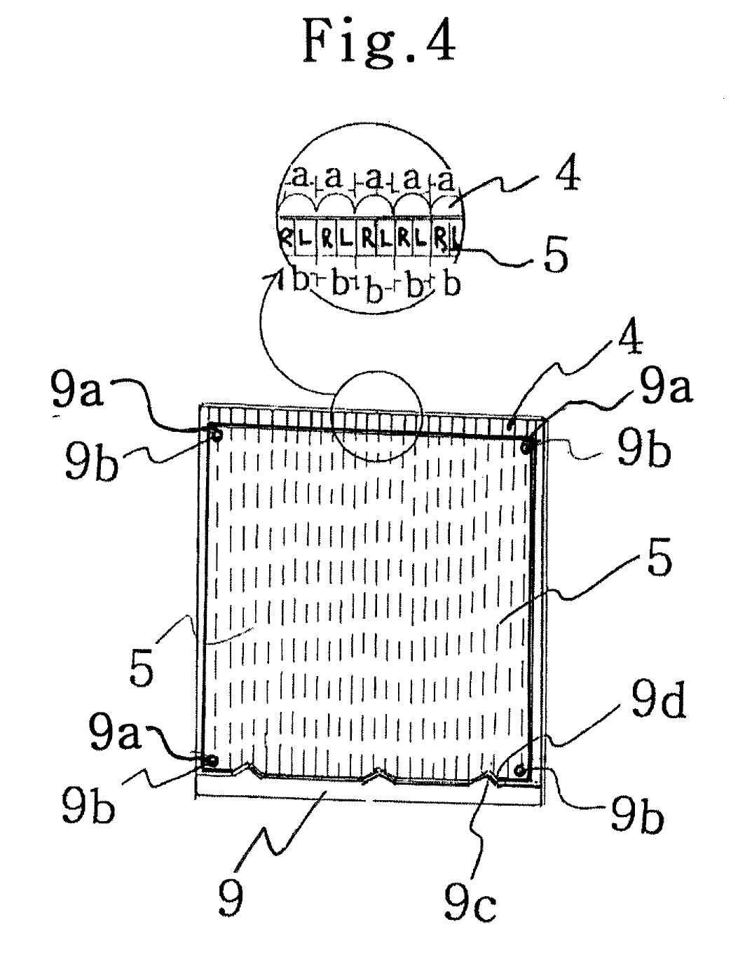

At this time, the interval b between the left-eye picture (R) and the right eye-picture (L) may be corresponded to a lens pitch a of the lenticular plate 4, as shown in FIGS. 3 and 4.

Here, the interval b between the left-eye picture (R) and the right eye-picture (L) and the lens pitch a of the lenticular plate 4 may not be limited specially, and even if it may be varied depending on a size of the 3D picture; however, the interval b of a 3D picture to be viewed from a distance of 1-5 m generally may be 0.2-10 mm and further it may be increased to 50 mm in case of a 3D picture to be viewed from a remote distance such as a bus or car.

Furthermore, a fixing groove 9b or a fixing frame 9d may be formed at a location of the 3D picture 5, corresponding location to a fixing pin 9a and a fixing plate 9c where is pre-determined by corresponding the interval b to the lens pitch a.

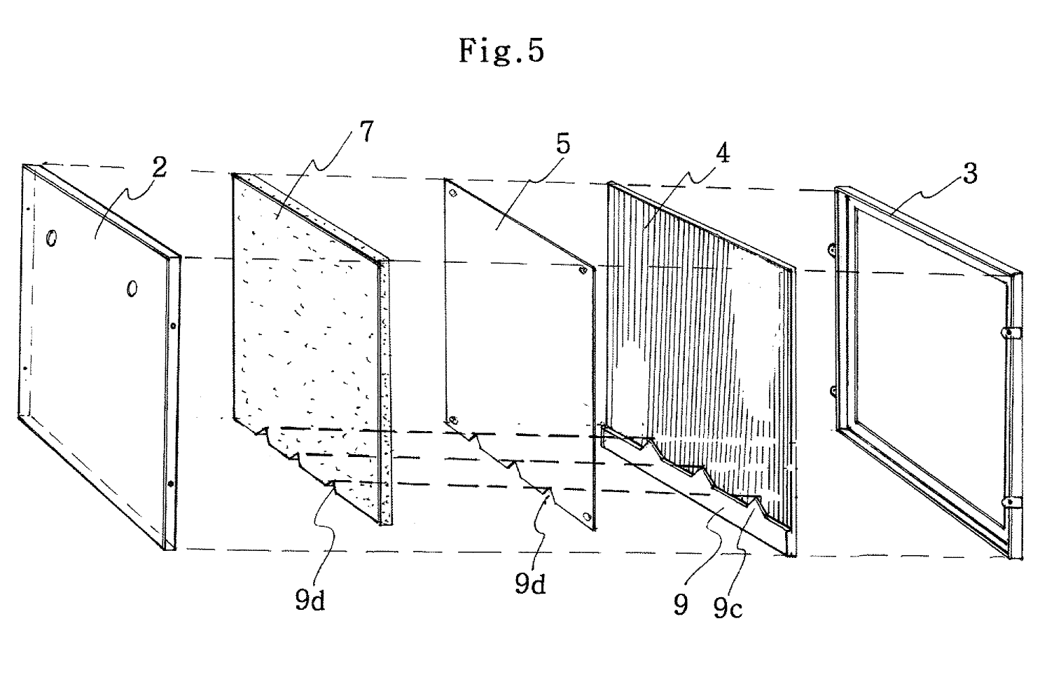

That is, as shown in FIGS. 4-5 and 7, at a location where the interval b corresponds to the lens pitch a, a 3D picture 5 may be arranged with respect to a lenticular plate 4 and further a fixing frame 9d of the 3D picture 5 may be arranged at a location corresponding to a fixing plate 9c formed on a picture fixing device 9. If necessary, as shown in FIG. 5, the fixing frame 9d may be arranged around a resilient plate 7.

Furthermore, as shown in FIGS. 4, and 6-7, the 3D picture may be arranged with respect to the lenticular plate 4 at a corresponding location of the interval b and the lens pitch a and further a fixing groove 9b of the 3D picture 5 may be arranged at a corresponding to a fixing pin 9a formed on a front case 3 or the lenticular plate 4.

Under the configuration as described in the forgoing, when the fixing groove 9b and the fixing frame 9d of the 3D picture is mounted to the fixing pin 9a or the fixing plate 9c formed on the lenticular plate 4, the lens pitch a of the lenticular plate 4 is corresponded to the interval b of the left-eye picture (R) and the right eye-picture (L).

Here, the fixing pin 9b and the fixing plate 9c may be formed around the resilient plate 7 of the main body case 2 to obtain the same effects as described in the forgoing.

As shown in FIGS. 1-2, and 5-12, a 3D picture bulletin board 1 may include a front case 3 and a main body case 2 wherein the front case 3 may be fixed to a rotation device 11 such as a hinge to be opened and closed based on one axis of the main body case 2, or a locking device 10 may be provided on one side of the main body case and front case to separate or connect the main body case 2 and the front case 3, and thereby replacing frequently the 3D picture.

Furthermore, the resilient plate 7 may be made of resilient material such as sponge or foaming urethane sheet.

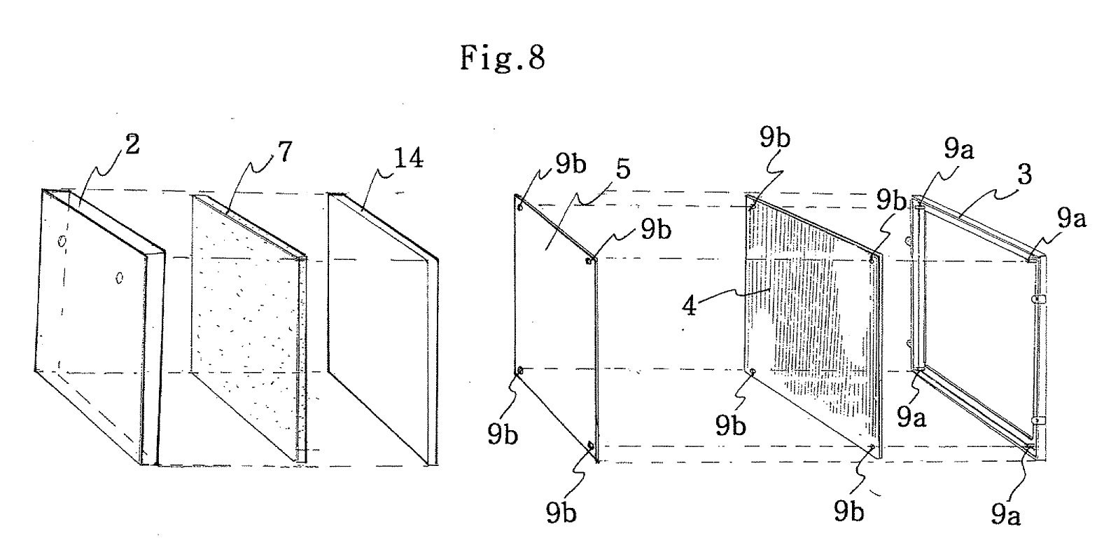

Meanwhile, as shown in FIGS. 8, 10 and 12, a thin illuminating plate 14 provided with a plurality of illuminating units 8 such as a general LED may be placed on a front surface of the resilient plate 7 to push simultaneously the illuminating plate 14 provided with a plurality of illuminating units 8 and the 3D picture to be in contact with the lenticular plate 4 through resilient force from the resilient plate 7.

Accordingly, a user may separate a front case 3 from a main body case 2 and a 3D picture 5 from a fixing pin 9a and a fixing plate 9c and then replace the 3D picture 5 with a new 3D picture and connect the front case 3 to the main body case 2 using the fixing pin and fixing frame. Through this simple process the 3D picture may be replaced and at the same time a lens pitch a of a lenticular plate 4 may be corresponded automatically to a interval b of the 3D picture.

Further, the fixing pin 9a and the fixing plate 9c may be provided at a location of a main body case 2, corresponding to a front case 3. That is, the fixing pin 9c and the fixing plate 9c which are formed at a location where the lens pitch a of a lenticular plate 4 corresponds to the interval b of the 3D picture 5 may be provided on an inner surface of the main body case 2.

Next, embodiments of the image changeable 3D stereoscopic posting apparatus according to the present invention will be described.

### Embodiment 1

FIG. 5 is a view illustrating a method for fixing a 3D picture 5 to a lenticular plate 4 using various fixing plate 9c according to the present invention.

That is, even through the fixing plate 9c is configured as a triangle form according to the present embodiment, it may be formed as a circular form or a square form. In this case, a fixing frame 9d formed on the 3D picture 5 may be provided, corresponding to the fixing plate 9c, at opposite location to the fixing plate 9c. For example, as shown in FIG. 5, the fixing frame 9d formed on a 3D picture and the fixing plate 9c formed on a lenticular plate may be provided as a concave-convex triangle form. In more detailed description, when the fixing plate 9c formed on a lenticular plate is provided as a triangle form, the fixing frame 9d formed on a 3D picture 5 may be a triangle form, which are shaped oppositely.

Of course, at this time, the locations of the fixing plate 9c formed on the lenticular plate and the fixing frame 9d formed on the 3D picture are determined, as shown in FIG. 4, by corresponding the lens pitch a of the lenticular plate 4 to the interval b between the left-eye picture (R) and the right eye-picture (L).

Accordingly, a shape of the fixing frame 9d may be mass-formed through one process on the 3D picture 5 printed by a separate process.

In summary, a 3D picture 5 may be replaced simply in such a manner that a front case 3 may be separated from a main body case 2 and the 3D picture 5 may be separated from a fixing pin 9a and then a fixing frame 9d of a new 3D picture to be replaced may be connected to a fixing pin.

### Embodiment 2

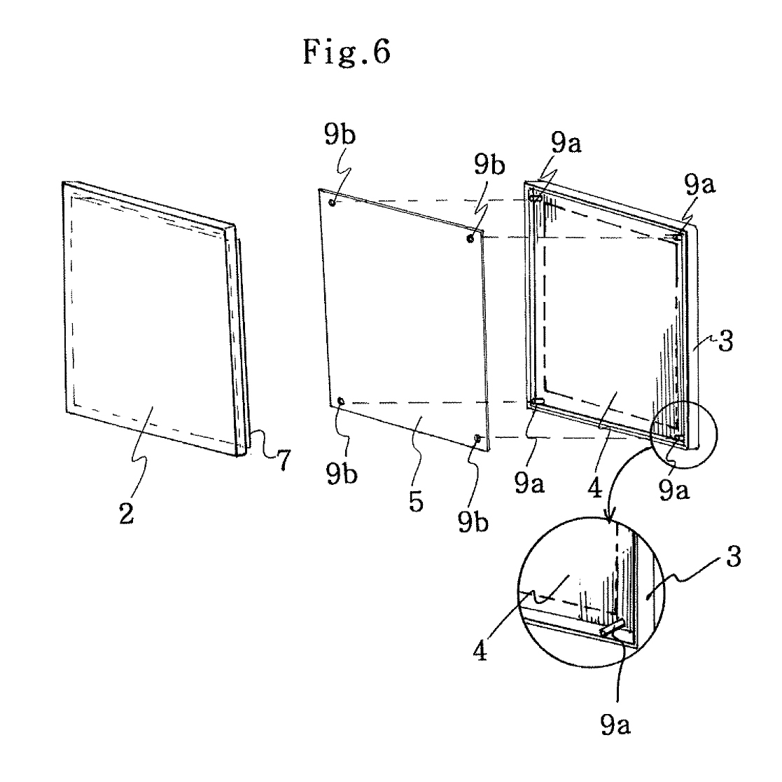

In FIG. 6, in order to fix a 3D picture to a lenticular plate 4 a fixing pin 9a may be formed at corners of the lenticular plate 4 or a front case 3 and a fixing groove 9b may be formed at locations of the 3D picture, corresponding to locations where the fixing pin is formed.

That is, the fixing pin 9a may be formed on an upper part, lower part, a part of left and right portions of the lenticular plate 4 or a rear surface of the front case 3 and further the fixing groove 9b for the 3D picture 5, corresponding to the fixing pin, may be formed on a rear surface of the front case 3 wherein left and right horizontal directions thereof correspond to left and right vertical directions.

However, as shown in FIG. 4, the fixing pin 9a and the fixing groove 9a may be formed at least two locations in order for the lens pitch a and the interval b to be fixed stably to the determined locations.

Preferably, as shown in FIG. 6, the fixing pin 9a may be formed at four corners of the lenticular plate 4 and further the fixing groove 9b may be formed at four corners of the 3D picture, corresponding to the fixing pins 9a.

In the present embodiment, the lens pitch a of the lenticular plate 4 and the interval b of the 3D picture 5 are corresponded automatically so that after the 3D picture 5 is replaced, the main body case 2 is connected to the front case 3 and then the resilient plate 7 mounted on the main body case 2 pushes the 3D picture 5 toward the lenticular plate 4 through its resilient force and thus 3D posters may be mass-replaced without an additional adjustment for showing 3D images.

### Embodiment 3

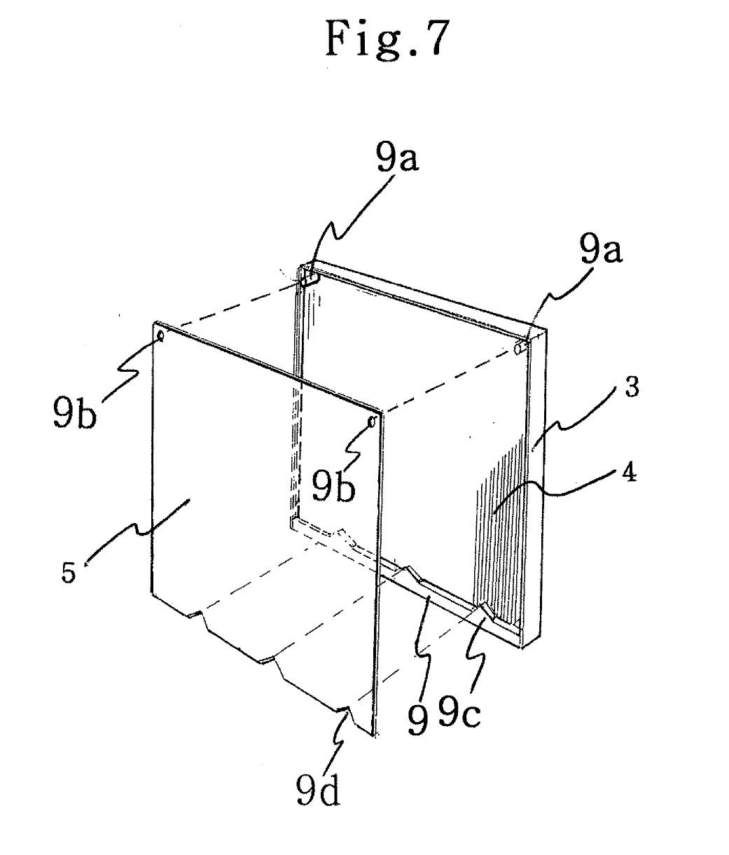

FIG. 7 is a partly sectional view illustrating a fixing pin 9a and a fixing plate 9c formed on a lenticular plate 4 which is mounted on a front case 3 and a fixing groove 9b and a fixing frame 9d formed on a 3D picture 5.

In the present invention, a combined configuration of the structures described in the Embodiments 1 and 2 is described wherein the 3D picture 5 may be fixed further stably to the lenticular plate 4.

### Embodiment 4

As shown in FIG. 8, an illuminating plate 14 may be further provided in the configurations as shown in FIGS. 5 and 6.

That is, as shown in FIG. 8, a fixing pin 9a may be formed on a front case 3 and a lenticular plate 4 may be provided toward the front case 3, and further a resilient plate 7 may be provided toward the main body case 2 and the illuminating plate 14 formed with LEDs may be provided at a front end of the resilient plate.

Here, a 3D picture 5 may be provided between the illumination plate 14 and the lenticular plate 4 wherein the 3D picture 5 may be formed with a transparent film as a sheet form to be printed thereon.

At this time, the locations of the fixing pin 9a and the fixing groove 9b may be determined in the same manner as Embodiments 1, 2 and 3 so that the lens pitch a of the lenticular plate 4 and the interval b of the 3D picture 5 may be corresponded automatically and further the resilient plate 7 provided on a front case 2 may push the illuminating plate 14 and at the same time the 3D picture 5 toward the lenticular plate 4, and thus 3D images can be viewed.

### Embodiment 5

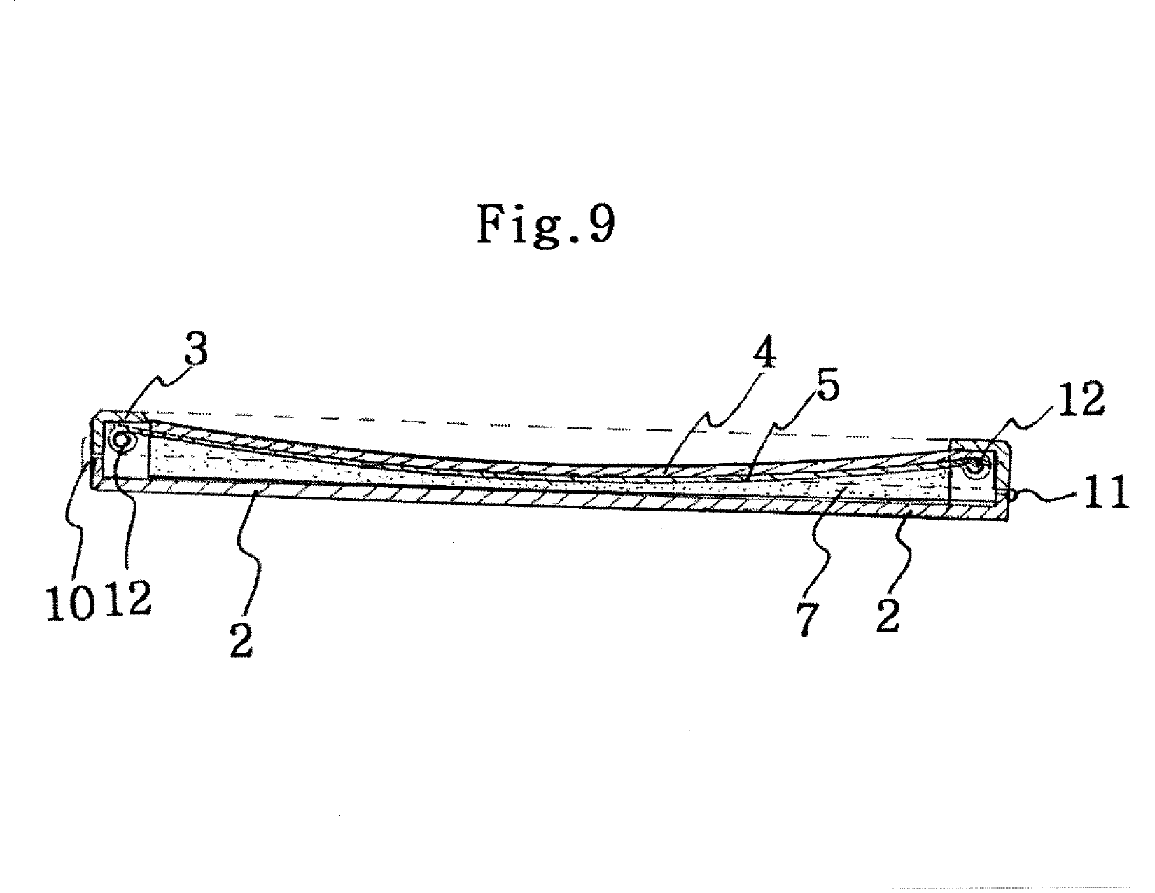

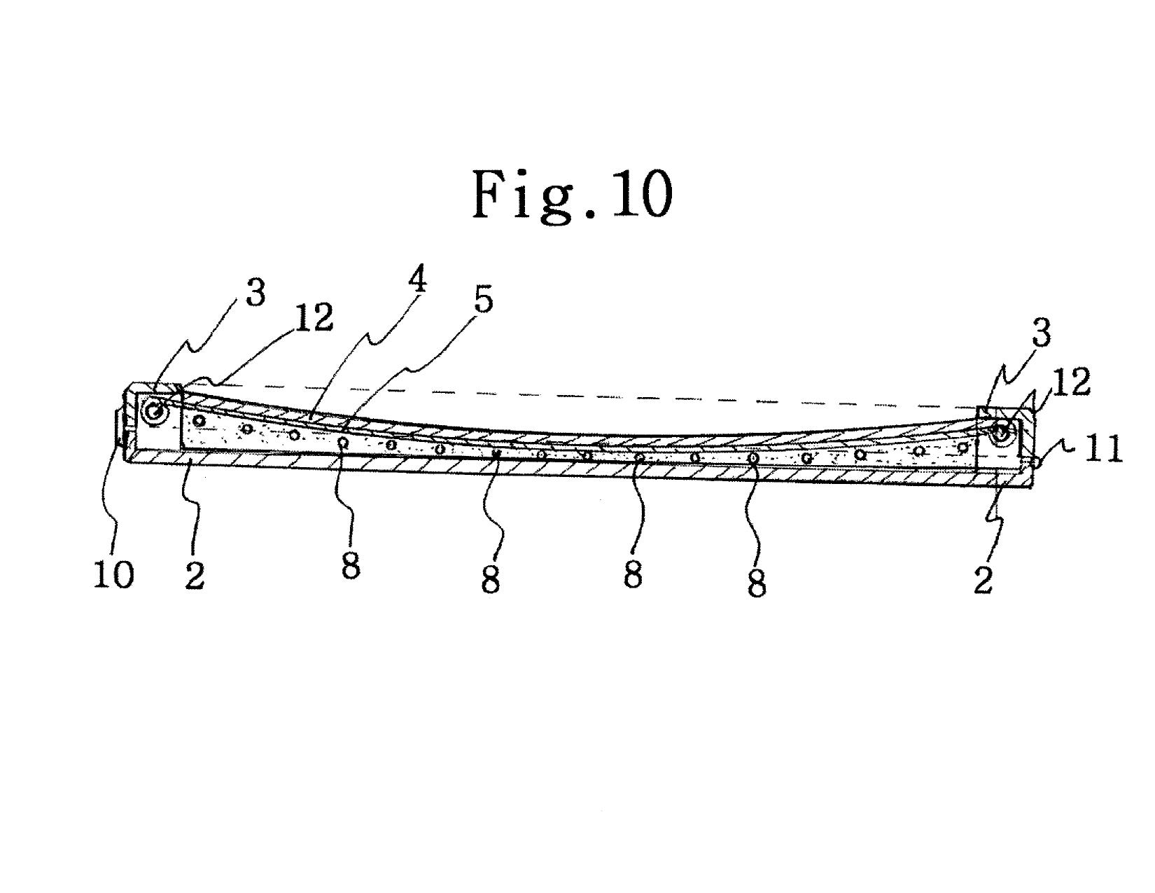

In the present Embodiment, as shown in FIG. 9, a lenticular plate 4 provided toward a front case 3 may be curved as a concave form. That is, when the lenticular plate 4 is curved as a concave form, as shown in FIGS. 9 and 10, the lenticular plate 4 may be fixed to a fixing frame 12 formed on left-right ends on an inner part of the front case 3 and a 3D picture 5 may be in contact easily and tightly with the curved lenticular plate 4.

Accordingly, the resilient plate 7 provided toward the main body case 2 may be deleted.

Here, when a 3D picture 5 is in contact with a lenticular plate 4 of a planar form, there may remain parts of the 3D picture 5 which are not in contact with the lenticular plate due to uneven planarity of the lenticular plate 4 or the 3D picture 5.

Meanwhile, when the lenticular plate is curved, as shown in FIG. 10, it may be effective to a transmission 3D poster through an illuminating device 8. Further, a configuration for fixing the 3D picture 5 to the lenticular plate 4.

### Embodiment 6

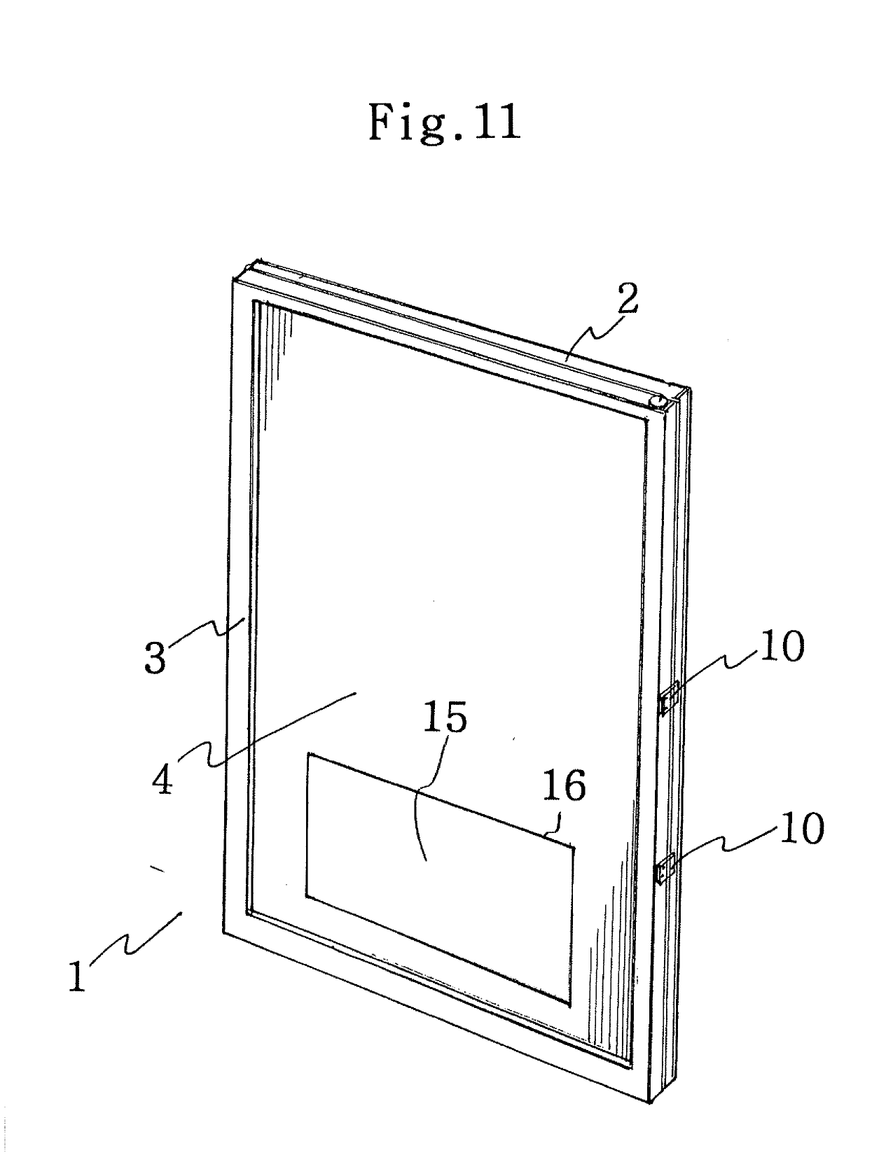

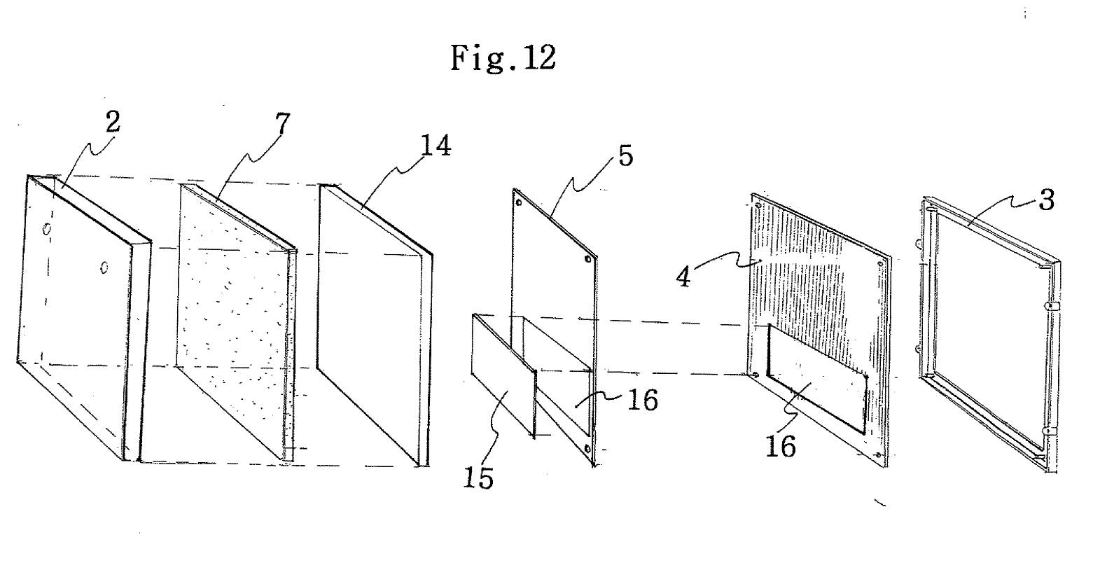

FIG. 11 is a view illustrating a posting apparatus through which a stopped 3D poster image and a 3D mobile image displayed on eye-glassless 3D image monitor 15 can be viewed simultaneously and FIG. 12 shows a detailed configuration of the structure as shown in FIG. 11.

As shown in FIGS. 11 and 12, a resilient plate 7 may be provided toward to a front case 3 and if necessary, an illuminating plate 14 may be provided, and further a known 3D image monitor 15 through which 3D image cab be viewed without an eyeglass may be provided. Here, a monitor window 16 is formed on both of the 3D picture 5 and the lenticular plate 4 to be assembled, through which a picture of the 3D image monitor 15 is protruded.

Here, the configurations of the fixing frame 9d and the fixing groove 9b, and the fixing pin 9a and the fixing plate 9c may be the same as preceding embodiments.

### Embodiment 7

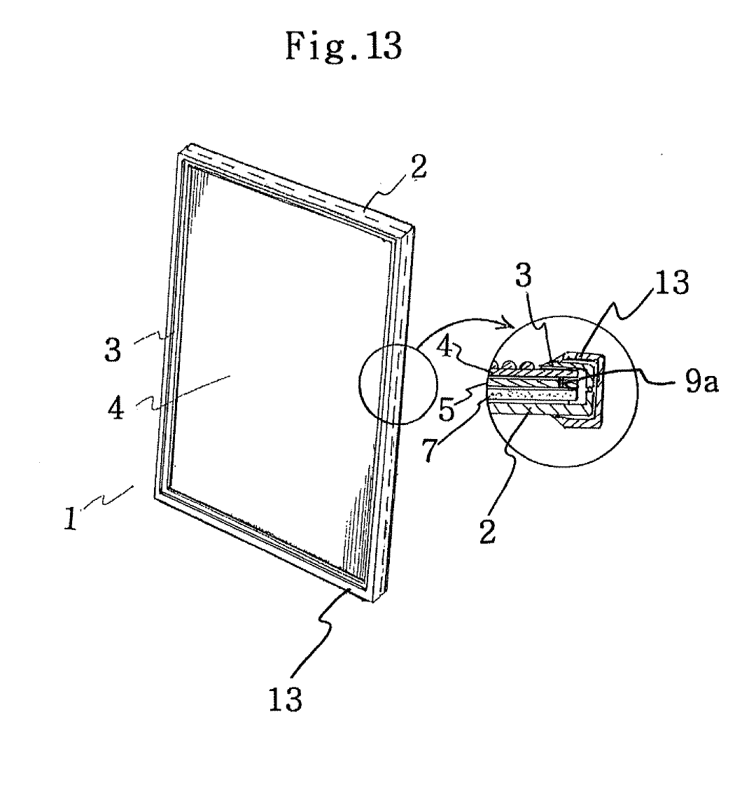

FIG. 13 is a view illustrating a posting apparatus to be installed on a car, a bus or a bus stop.

When the posting apparatus is installed outside, inner parts of the posting apparatus has to be protected from a rain, moisture and exhaust gas.

Accordingly, a moistureproofing ring 13 may be provided to a configuration as shown in FIGS. 1-2, 5-6, and 8-11. That is, as shown in FIG. 13, the moistureproofing ring 13 may be provided around an assembled main body case 2 and front case 3, on which a lenticular plate 4, a 3D picture 5, a fixing pin, and an illuminating plate, if necessary, are mounted.

Here, the moistureproofing ring 13 may be made of elastic material such as urethane, silicon louver or rubber to surround and be in contact with the assembled main body case 2 and front case 3 so that rain drops, dust and exhaust gas can be prevented from being entered into the posting apparatus.

Specially, when the illuminating plate 14 is provided, the effects can be doubled.

In the present embodiment, in order to replace a 3D picture 5 the moistureproofing ring 13 may be taken off and the front case 3 is to be opened for the 3D picture 5 to be separated from the fixing pin 9a and the 3D pictures are exchanged and then the front case 3 is to be closed and the moistureproofing ring 13 is covered thereon.

Meanwhile, the configurations of the fixing frame 9d and the fixing groove 9b, and the fixing pin 9a and the fixing plate 9c may be the same as preceding embodiments.

Accordingly, a posting apparatus according to the present embodiment when it is assembled to a large supporting bar may be applied to a large 3D advertising device which may be installed to a road or a building wall.

### Embodiment 8

The posting apparatus configurations as described in embodiments 1-7 may be applied to a 3D image advertising device, which may be installed on a taxi or a car.

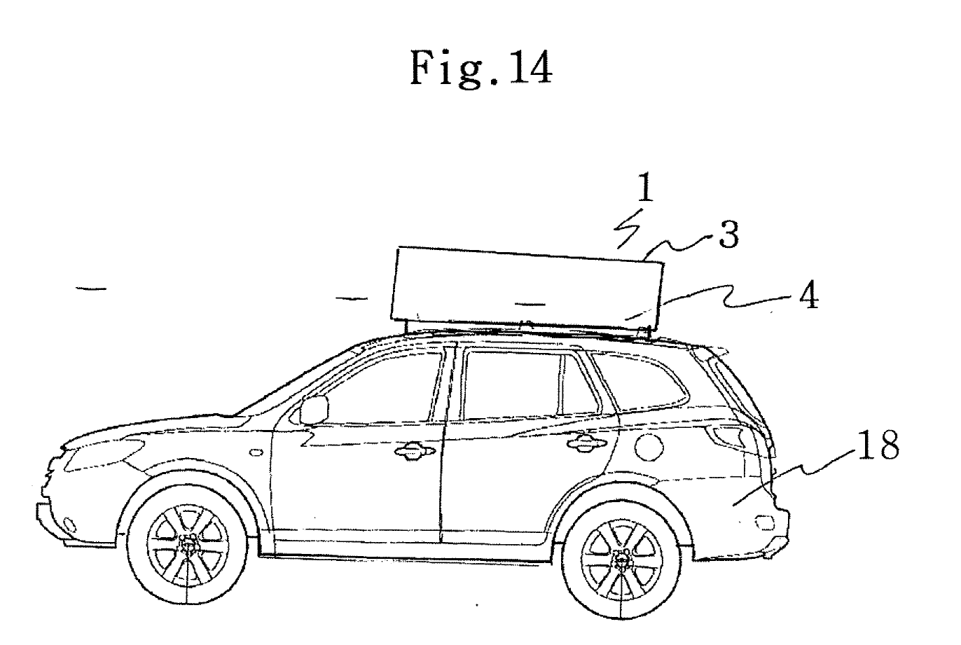

That is, as shown in FIG. 14, a single or plural posting apparatus may be installed on upper end of a car 13, or a front surface or a rear surface of a car. Here, it is possible for three posting apparatuses may be installed on a roof of a car as three stereoscopic bulletin boards 1 of a triangle form.

Here, a moistureproofing ring 13 may be further provided to the posting apparatus configuration as described above.

Meanwhile, the configurations of the fixing frame 9d and the fixing groove 9b, and the fixing pin 9a and the fixing plate 9c may be the same as preceding embodiments.

### Embodiment 9

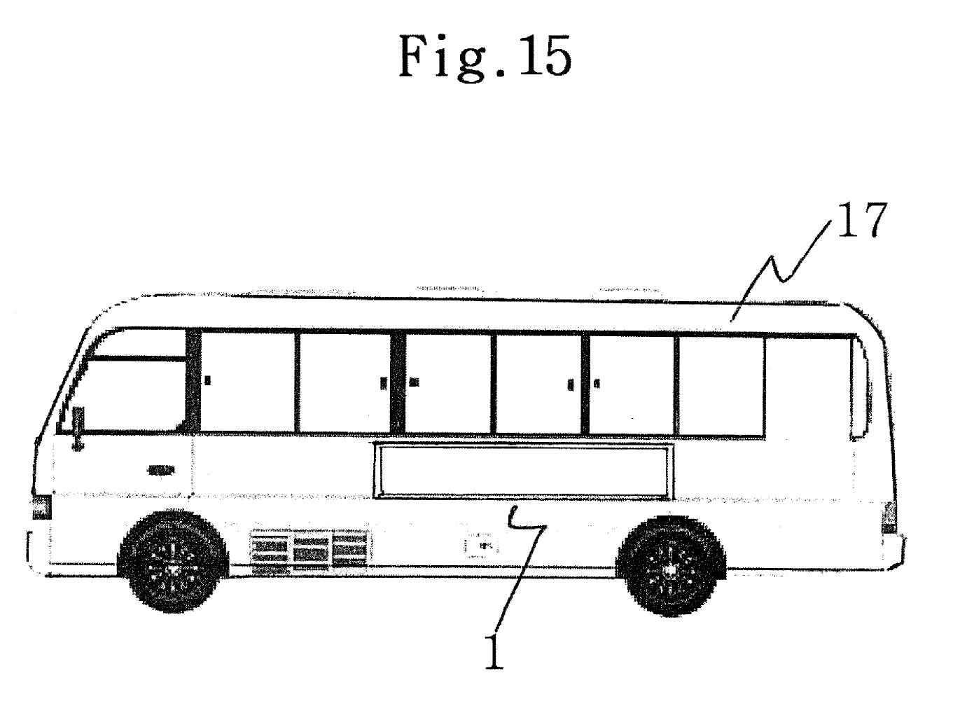

As shown in FIG. 15, the posting apparatus configurations as shown in FIGS. 1-2, 5-6, 8-10 and 13 may be applied selectively to a rear side, or both sides of a bus 17.

Specially, a moistureproofing ring 13, as shown in FIG. 13, may be provided on the posting apparatus installed on a bus 17 for preventing rain drops, moisture and exhaust gas from being entered into the posting apparatus.

Here, the configurations of the fixing frame 9d and the fixing groove 9b, and the fixing pin 9a and the fixing plate 9c may be the same as preceding embodiments.

### Embodiment 10

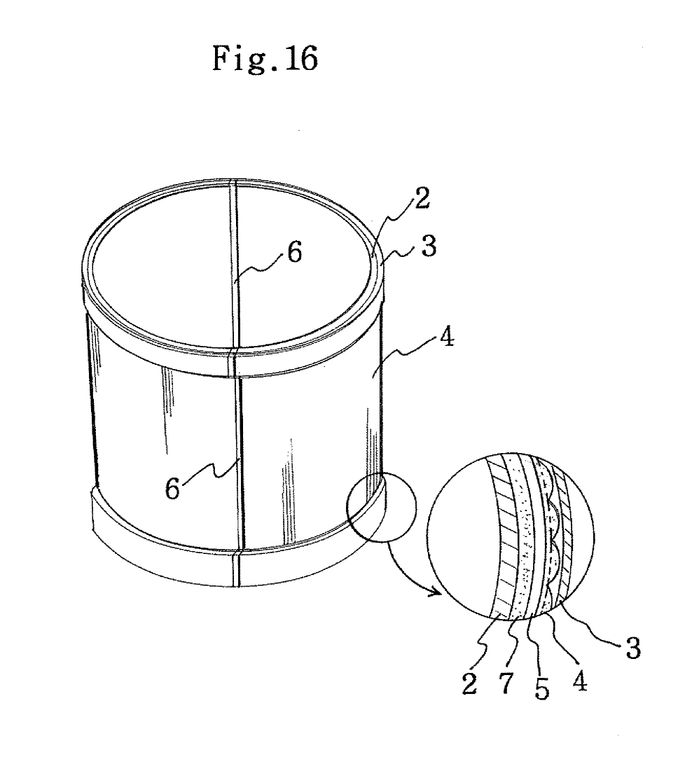

In the present embodiment as shown in FIG. 16, a posting apparatus may be formed as a cylindrical pillar form, or may be installed on a cylindrical pillar.

That is, the configurations as shown in FIGS. 1-2, 5-6, 8-10 and 13 may be curved and divided into two, three or four parts per a separation ring 6 by a division ring 21.

That is, as shown in FIG. 16, a main body case 2 and a front case 3, on which a lenticular plate 4, a 3D picture 5, a resilient plate 7 and if necessary, an illuminating plate 14 are provided, may be curved and the lenticular plate 4 and the front case 3 may be separated from the main body case 2 by the separation ring 6 or connected.

In the present embodiment, the configurations of the fixing frame 9d and the fixing groove 9b, and the fixing pin 9a and the fixing plate 9c may be the same as preceding embodiments.

Accordingly, the posting apparatus according to the present invention may be applied as a posting device in a theater, a 3D posting device inside a subway, an outdoor 3D advertising device or a 3D posing device of a car or a bus wherein 3D picture can be printed through a general printing method and thus the 3D picture which is mass-printed at low cost can be replaced easily and efficiently.

According to the present invention, when a 3D picture is fixed to a picture fixing device, a lens interval of the lenticular plate corresponds automatically to a picture interval by the picture fixing device, and thus anyone can view the 3D image and further in many places many 3D pictures can be replaced.

Further, after replacing the 3D picture, the front case is connected to the main body case and then elastic material on a rear surface of the case pushes the 3D picture toward the lenticular plate and 3D image viewing effect is obtained promptly.

Meanwhile, according the present invention, 3D image can be viewed without 3D eye-glass, and further the 3D picture is configured by arranging the left and right eye pictures in sequence as a separate sheet and thus can be mass-printed using a general printing method.

Accordingly, by replacing the printed 3D picture without replacing the lenticular plate, 3D poster including various 3D advertizing image can be provided and replaced frequently by anyone.

Furthermore, a 3D image monitor is connected to a part of the posting apparatus and thus 3D poster and 3D mobile image can be viewed simultaneously on one posting apparatus.

While the invention has been shown and described with reference to exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

1. A picture changeable stereoscopic posting apparatus, comprising:
a front case (3) and a main body case (2) formed as a frame, respectively;
a lenticular plate (4) mounted on the front case (3);
a picture fixing device (9) provided with a fixing pin (9a) and a fixing plate (9c) for fixing a 3D picture (5) at locations for the 3D picture to be viewed, of a rear surface of the lenticular plate (4) of the front case (3) or the main body case (2);
a 3D picture (5) printed on a separate printing paper; and
a resilient plate (7) which is made of elastic material such as sponge or urethane sheet and is provided inside the front case 2 wherein the front case (3) is opened from the main body case (2) for the 3D picture 5 to be replaced frequently.

2. The picture changeable stereoscopic posting apparatus of claim 1, wherein the 3D picture (5) comprises a left eye picture (R) and a right eye picture (L) which are fine-divided into a plurality of pictures and are arranged vertically in sequence to be combined as single picture.

3. The picture changeable stereoscopic posting apparatus of claim 1, wherein a fixing pin (9a) and a fixing groove (9b) formed, respectively, at locations where a lens pitch a of the lenticular plate (4) corresponds to a picture interval b of the left and right eye pictures (R,L) are provided on the lenticular plate (4) and the 3D picture (5), respectively.

4. The picture changeable stereoscopic posting apparatus of claim 1, wherein a fixing plate (9c) and a fixing frame (9d) formed, respectively, at locations where a lens pitch a of the lenticular plate (4) corresponds to a interval b of the 3D picture are provided on the lenticular plate (4) of the front case (3) and the 3D picture (5), respectively.

5. The picture changeable stereoscopic posting apparatus of claim 1, wherein a fixing pin (9a) which is installed fixedly to a location where a lens pitch a of the lenticular plate (4) corresponds to an interval b of the 3D picture is formed on an inner surface of the front case (2).

6. The picture changeable stereoscopic posting apparatus of claim 1, wherein a fixing plate (9c) which is installed fixedly to a location where a lens pitch a of the lenticular plate (4) corresponds to an interval b of the 3D picture is formed on an inner surface of the front case (2).

7. The picture changeable stereoscopic posting apparatus of claim 1, wherein the lenticular plate is shaped as a curved form.

8. The picture changeable stereoscopic posting apparatus of claim 1, wherein an illuminating plate (14) is provided on a front case (2) and the 3D picture (5) is made of transparent film.

9. The picture changeable stereoscopic posting apparatus of claim 1, wherein the resilient plate (7) is mounted to a front surface of the main body case (2) and a known 3d image monitor (15) is provided on a front surface of the main body case, and monitor windows (16) are provided on the 3D picture (5) and the lenticular plate (4), respectively, so that a picture of the 3D image monitor (15) is exposed.

10. The picture changeable stereoscopic posting apparatus of claim 1 mounted to a car (18) as a 3D image advertizing device.

11. The picture changeable stereoscopic posting apparatus of claim 1 mounted to a bus (17) as a 3D image advertizing device.

12. The picture changeable stereoscopic posting apparatus of claim 1 shaped as a circular form.

13. A picture changeable stereoscopic posting apparatus, comprising:
a front case (3) and a main body case (2) formed as a frame, respectively;
a lenticular plate (4) mounted on the front case (3);
a picture fixing device (9) provided with a fixing pin (9a) and a fixing plate (9c) for fixing a 3D picture (5) at locations for the 3D picture to be viewed, of a rear surface of the front case (3);
a 3D picture (5) which is printed on a separate printing paper and includes a left eye picture (R) and a right eye picture (L) which are fine-divided into a plurality of pictures and are arranged vertically in sequence to be combined as single picture;
a resilient plate (7) which is made of elastic material such as sponge or urethane sheet and is provided on the main body case (2); and
a water proofing ring formed with elastic material and provided outside a case assembled by the front case (2) and the front case (3).

14. The picture changeable stereoscopic posting apparatus of claim 13 mounted to a car (18) as a 3D image advertising device.

15. The picture changeable stereoscopic posting apparatus of claim 13 mounted to a bus (17) as a 3D image advertising device.

16. The picture changeable stereoscopic posting apparatus of claim 13 mounted along a road as a 3D image advertising device.
